(19) United States
(12) Patent Application Publication
(10) Pub. No.: US 2018/0110183 A1
(43) Pub. Date: Apr. 26, 2018

(54) KERNEL REMOVING APPARATUS AND METHOD

(71) Applicants: James L. Soper, Frankfort, IL (US); Donald P. Soper, Cornell, MI (US)

(72) Inventors: James L. Soper, Frankfort, IL (US); Donald P. Soper, Cornell, MI (US)

(21) Appl. No.: 15/791,842

(22) Filed: Oct. 24, 2017

Related U.S. Application Data
(60) Provisional application No. 62/411,914, filed on Oct. 24, 2016.

(51) Int. Cl. A01F 11/06

(52) U.S. Cl. CPC A01F 11/06

(57) ABSTRACT

A kernel removing apparatus and method for removing corn kernels from a cob of corn or similar food item. The kernel removing apparatus comprises a first housing and a second housing. The first housing includes a sidewall forming an enclosed interior volume, a base, a motor, a gearbox, and a power source. The second housing includes a driveshaft and a cutting assembly that are operably connected to the gearbox and the motor of the first housing. When the motor is actuated, the gearbox rotates the driveshaft and the cutting assembly, wherein the cutting assembly removes corn kernels from a cob of corn, while the core of the cob is received within the tubular member of the cutting assembly. The kernel removing apparatus further includes a slidably securable conduit member having an input port that receives the cob of corn and an output port that dispenses the kernels.

### CROSS REFERENCE TO RELATED APPLICATION

This application claims the benefit of U.S. Provisional Application No. 62/411,914 filed on Oct. 24, 2016. The above identified patent application is herein incorporated by reference in its entirety to provide continuity of disclosure.

### BACKGROUND OF THE INVENTION

Corn is a popular food that is eaten both as separated kernels as well as directly off the cob. Many people find it either difficult or undesirable to eat corn directly off the cob, as it can be messy and cumbersome to handle manually, and is often prone to becoming uncomfortably lodged between one's teeth. As such, many individuals prefer to remove the kernels from the cob and eat the kernels separately.

There are numerous ways in which one may remove the kernels of corn from the cob. The most rudimentary method involves holding a cob or corn by hand and removing the kernel with the blade of a knife. This method is both tedious and time consuming. Furthermore, it can be difficult to remove a kernel at a consistent desired length. Additional methods include using specialized tools for kernel removal. One such tool involves placing a cob of corn within a cylinder and manually pushing down on a circular blade along the surface of the corn. While this method may be suited for a limited amount of corn, it can be physically difficult. This is especially true for older and weaker individuals, such as those suffering from arthritis.

The present invention, however, provides a device that overcomes these disadvantages and shortcomings of the prior attempted devices. The present invention provides a corn kernel removing apparatus that is powered by an electric motor. Therefore, removing kernels from a cob of corn takes less time and requires less effort on the part of the user, which is beneficial for persons with limited manual strength. In addition, the efficiency of the motor allows the kernel removing apparatus to be easily used in a commercial setting.

Further, the motor is mounted within a first housing and coupled to a second housing containing a cutting assembly. The second housing further comprises an input port and an output port, wherein the input port is configured to receive a food item and the output port discharges removed material from the food item into a receptacle. Thus, the kernels are easily collected in the receptacle, requiring less clean up.

In light of the devices disclosed in the known art, it is submitted that the present invention substantially diverges in design elements from the known art and consequently it is clear that there is a need in the art for an improvement to existing kernel removing devices. In this regard the instant invention substantially fulfills these needs.

### SUMMARY OF THE INVENTION

In view of the foregoing disadvantages inherent in the known types of kernel removing devices now present in the known art, the present invention provides a new kernel removing apparatus and method wherein the same can be utilized for providing convenience for the user when removing corn kernels from a cob of corn.

It is therefore an object of the present invention to provide a new and improved kernel removing apparatus and method that has all of the advantages of the known art and none of the disadvantages.

It is another object of the present invention to provide a kernel removing apparatus comprising a first housing removably secured to a second housing. The first housing comprises a sidewall forming an enclosed interior volume, a base affixed to a lower end of the sidewall, a motor affixed to the sidewall, wherein the motor is disposed within the enclosed interior volume, a gearbox, wherein the gearbox is operably connected to the motor, a sleeve rotatably secured to the gearbox, wherein the sleeve is configured to receive a driveshaft, an aperture disposed within a first sidewall configured to receive the sleeve therethrough, a power source, and a switch configured to actuate the motor. The second housing comprises an elongated tubular body having a first end and second end, wherein the first end is removably secured to the first sidewall of the first housing, a driveshaft having a first end and a second end, wherein the driveshaft is disposed within the elongated tubular body such that the first end of the driveshaft removably secures to the sleeve of the first housing, and a cutting assembly including a hollow tubular member having an open first end and a closed second end, wherein the first end comprises a circular blade and the second end is removably securable to the second end of the driveshaft.

Another object of the present invention is to provide a conduit member having an input port, an output port, and a removably securable channel, wherein the channel slidably attaches to the second end of the elongated tubular body.

Yet another object of the present invention is to provide a kernel removing apparatus wherein the first housing includes a dial configured to adjust the speed of the motor, such that the revolutions per minute of the driveshaft can be increased and decreased.

Another object of the present invention is to provide a kernel removing apparatus that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the kernel removing apparatus.

FIG. 2 shows a side cross sectional view of an embodiment of the kernel removing apparatus.

FIG. 3 shows a perspective view of one embodiment of the kernel removing apparatus in use.

### DETAILED DESCRIPTION OF THE INVENTION

Reference is made herein to the attached drawings. Like reference numerals are used throughout the drawings to depict like or similar elements of the kernel removing apparatus and method. For the purposes of presenting a brief and clear description of the present invention, the preferred embodiment will be discussed as used for removing corn kernels from a cob of corn. However, in alternative embodiments, the kernel removing apparatus may be used to remove an outer layer from other food items, such as carrots or cucumbers, and is not limited for use with cobs of corn. The figures are intended for representative purposes only and should not be considered to be limiting in any respect.

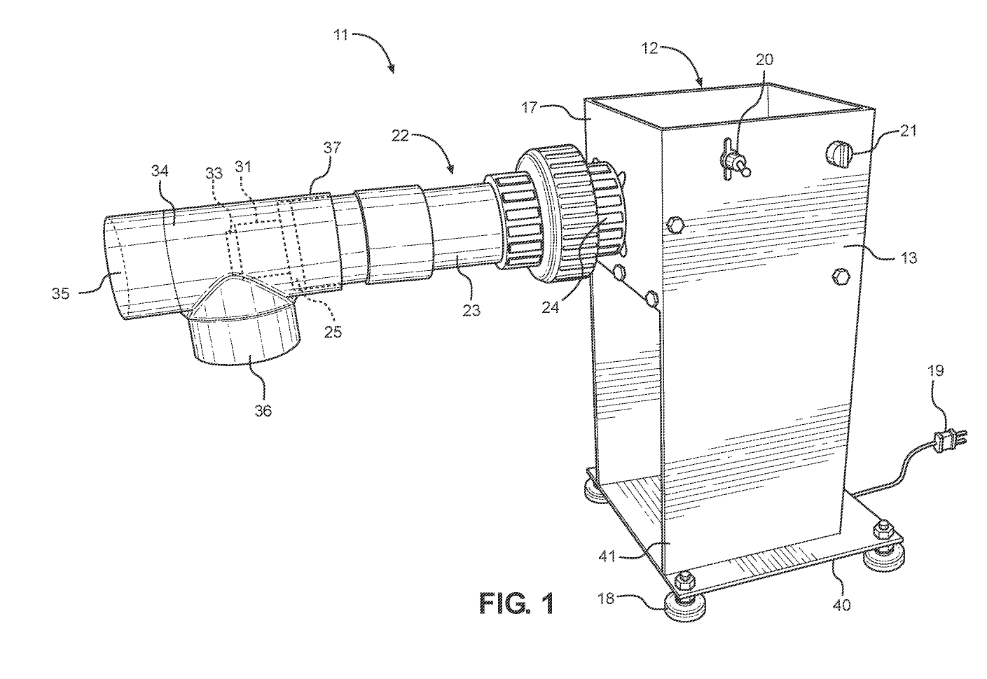

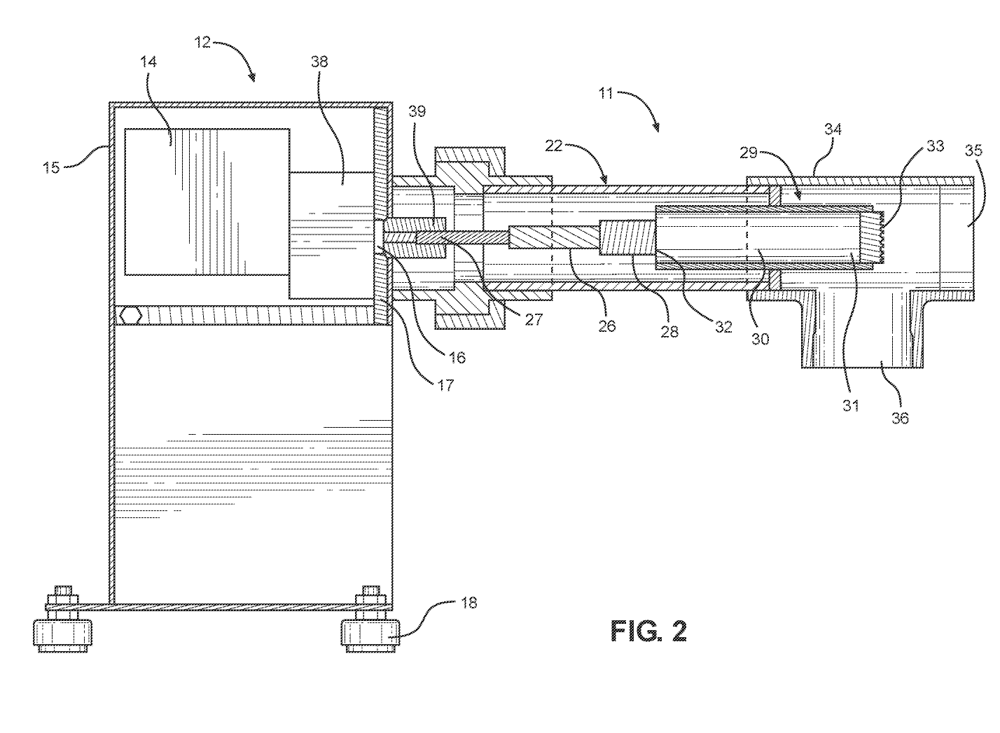

Referring now to FIG. 1 and FIG. 2, there is shown a perspective view of an embodiment of the kernel removing apparatus and a side cross sectional view of an embodiment of the kernel removing apparatus, respectively. The kernel removing apparatus 11 comprises a first housing 12 and a second housing 22, wherein the second housing 22 removably secures to the first housing via a fastener 24. The first housing 12 includes a motor 14 and a gearbox 38 that rotate a cutting assembly 29 disposed within the second housing 22, wherein the cutting assembly 29 is configured to remove corn kernels from a cob of corn.

The first housing 12 includes at least one sidewall 13 forming an enclosed interior volume and a base 40 attached to a lower end 41 of the sidewall 13. In the illustrated embodiment, the first housing 12 is substantially rectangular and includes openings that allow a user to access the internal components stored therein. However, in alternative embodiments the first housing 12 can be any suitable shape. In the illustrated embodiment, the base 40 extends beyond the lower end 41 of the sidewalls 13 of the first housing 12 in order to stabilize the apparatus due to the weight of the motor 14 and the gearbox 38. The base 40 further includes a plurality of footings 18 configured to stabilize the apparatus 11 when placed on an uneven surface. The footings 18 may be adjustable in height and include a padding, such as rubber, that prevents the apparatus 11 from moving while in operation. The first housing 12 further includes a plurality of bolts 42 that are configured hold the housing 12 and internal components, such as the motor 14 and gearbox 38 in place. The motor 14 is affixed to an upper end 15 of the sidewall 13 within the enclosed interior volume of the first housing 12. The gearbox 38 is disposed within the upper end 15 of the first housing 12, wherein the gearbox 38 is operably connected to the motor 14. The motor 14 is electrically connected to a power source 19 and a switch 20 disposed on the sidewall 13 of the first housing 12, such that when the switch 20 is actuated, the motor 14 turns a gear of the gearbox 38.

In the illustrated embodiment, the power source 19 for the motor 14 is configured as an electrical plug, wherein the alternating current power source 19 comes from a common electrical outlet. In other embodiments, the motor 14 is powered by a direct current power source 19, such as a portable battery that may be stored within the first housing 12. The battery may be rechargeable, offering the portability to use the kernel removing apparatus 11 in an outdoors setting.

The gearbox 38 includes a sleeve 39 that is configured to receive a first end 27 of a driveshaft 26. The first end 27 of the driveshaft 26 is configured to removably secure to the sleeve 39, such that the driveshaft 26 can be removed when the apparatus 11 is in a stored configuration. In some embodiments, the sleeve 39 is configured with a quick connect coupling system or a threaded connection that removably secures the driveshaft 26 thereto. The sleeve 39 is rotatably affixed to the gearbox 38 and configured to rotate when the motor 14 is actuated, which in turn rotates the driveshaft 26. The sleeve 39 operably attaches to the gearbox 38 through an aperture 16 disposed within a first sidewall 17 of the first housing 12. The first housing 12 further includes a dial 21 disposed on a sidewall 13, such that the dial 21 is configured to control the revolutions per minute (RPM) of the driveshaft 26. The dial 21 offers a range of rotational speed in order to maximum the optimal speed and torque combination ideal for removing kernels from corn.

The second housing 22 comprises an elongated tubular body 23 having a fastener 24 on a first end, wherein the fastener 24 is configured to removably secure to the first sidewall 17 of the first housing 12. This allows the second housing 22 to be removed from the first housing 12 in order to access any internal components of the second housing 22 or to place the apparatus in a stored configuration. In the illustrated embodiment, the fastener 24 is configured as a threaded member, that is screwed to the first housing 12. However, any suitable fastener may be used, such as a quick connect coupling fastener, configured to easily attach and remove the second housing 22 from the first housing 12. This provides convenience when a user wishes to disassemble and transport the kernel removing apparatus 11. In some embodiments the elongated tubular body 23 of the second housing 22 comprises a polymer construction, such as readily available polyvinyl chloride (PVC) piping. Such construction reduces the weight of the kernel removing apparatus while maintaining structural rigidity.

The second housing 22 further comprises a driveshaft 26 and a cutting assembly 29 therein. The cutting assembly 29 includes an elongated tubular member 30 having an open first end 31 and a closed second end 32. The elongated tubular member 30 has a hollow interior adapted to accommodate the length of a food item such as a cob of corn. The open first end 31 includes a circular blade 33 affixed thereto. The circular blade 33 comprises a ring shape with a plurality of serrated blades thereon. However, in alternative embodiments, the circular blade 33 may include various blade configurations, such as a straight blade, used for removing various surfaces from food items. The closed second end 32 of the cutting assembly 29 is removably secured to a second end 28 of the driveshaft 26. When secured, the driveshaft 26 is configured to rotate the cutting assembly 29 when the switch 20 on the first housing 12 is actuated.

In alternative embodiments, the kernel removing apparatus 11 includes a plurality of cutting assemblies 29 comprising varying diameters and circular blades 33. Each cutting assembly 29 is configured to be mountable to the driveshaft 26. This allows the kernel removing apparatus 11 to be used with a variety of food items and functions. In use, the cutting assembly 29 and blade 33 type can be chosen depending on the desired food item and desired function. For example, removing the kernels of a cob of corn will use a first cutting assembly, while peeling a cucumber or zucchini will use an alternate cutting assembly 29 with a different diameter and blade type. A cutting assembly 29 with a smaller diameter may be used to remove the core of an item. The user mounts the cutting assembly 29 having a diameter approximately the width of a core that is to be removed. The food item is then inserted into the cutting assembly 29 while the motor 14 is engaged. For example, the core of a large carrot may be removed using this method. Once the carrot is fully inserted into the cutting assembly 29, the desired outer later is removed. The undesired core remains within the elongated tubular member 30, and can be easily discarded after the motor 14 is powered down.

The second housing 22 further includes an attachable conduit member 34. The conduit member 34 comprises an input port 35, an output port 36, and a channel 37, wherein the channel 37 slidably attaches to the second end 25 of the elongated tubular body 23 of the second housing 22. The channel 37 remains in place on the second end 25 of the elongated tubular body 23 via a friction fit. In some embodiments, the channel 37 may include a screw threading to provide a more secure mount. In the illustrated embodiment, the conduit member comprises a cylindrical “T” shaped housing wherein the input port 35 and channel 37 are disposed along a first axis, and the output port 36 is disposed perpendicular thereto. However, in alternative embodiments the conduit member can be any suitable shape.

The input port 35 of the conduit member 34 is adapted to receive a food item, such as a cob of corn, therein. The input port 35 positions the cob in line with the cutting assembly 29, such that the circular blade 33 contacts the desired cutting area. The output port 36 is configured to dispense kernels that are removed from the cob by the circular blade 33 in a downward direction. In some embodiments, the output port may have a funnel shape that guides the kernels toward a receptacle placed there below. The conduit member 34 may be constructed from a transparent or semi-transparent material to allow a user to easily view the food item while the cutting assembly 29 is engaged. The conduit member 34 prevent kernels or other removed surfaces from being projected from the apparatus 11, while the cutting assembly is in use.

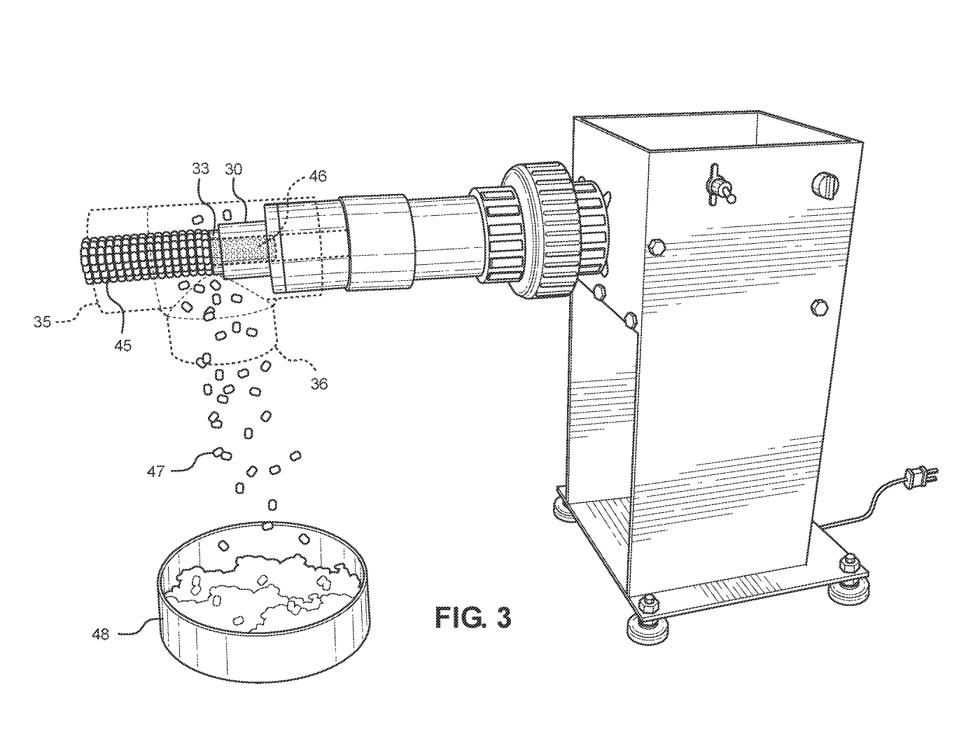

Referring now to FIG. 3, there is shown a perspective view of an embodiment of the kernel removing apparatus in use. In use, a receptacle 48 is placed directly underneath the output port 36 of the conduit member. The input port 35 is configured to receive a food item in which an outer portion is to be removed. If the kernel removing apparatus is being used to remove a desired portion of the food, such as kernels 47 of corn from a cob 45, the kernels 47 are deposited into the receptacle 48 after being removed from the cob 45 by the circular blade 33. If the kernel removing apparatus is being used to removed undesired items, such as the outer skin of a vegetable, the output port 36 may be placed directly above a waste container. When the kernel removing apparatus is used for removing a core 46 of a food item, the undesired core 46 remains within the hollow tubular body 30 of the cutting assembly and the desired outer shell is extracted from the cutting assembly. The height positioning of the output port 36 relative to the receptacle 48 allows the apparatus to be used in a commercial setting, such that a larger receptacle 48 will fit underneath the output port 36 in order to receive removed kernels from multiple cobs of corn.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A kernel removing apparatus, comprising:
a first housing comprising:
a sidewall forming an enclosed interior volume;
a base affixed to a lower end of the sidewall;
a motor disposed within the enclosed interior volume;
a gearbox, wherein the gearbox is operably connected to the motor;
a sleeve rotatably secured to the gearbox, wherein the sleeve is configured to receive a driveshaft;
an aperture disposed within a first sidewall configured to receive the sleeve therethrough;
a power source;
a switch configured to actuate the motor;
a second housing comprising:
an elongated tubular member having a first end and second end, wherein the first end is removably secured to the first sidewall of the first housing;
a driveshaft having a first end and a second end, wherein the driveshaft is disposed within the elongated tubular member such that the first end of the driveshaft connects to the sleeve of the first housing; and
a cutting assembly comprising a hollow tubular body having an open first end and a closed second end, wherein the first end comprises a circular blade and the second end is removably securable to the second end of the driveshaft; and
a conduit member having an input port, an output port, and a channel, wherein the channel receives the second end of the elongated tubular member.

2) The kernel removing apparatus of claim 1, wherein a plurality of footings are disposed on the base.

3) The kernel removing apparatus of claim 1, wherein the first housing includes a dial operably connected to the motor, wherein the dial is configured to adjust the speed of the motor, such that the revolutions per minute of the driveshaft can be increased and decreased.

4) The kernel removing apparatus of claim 1, wherein the circular blade comprises a plurality of serrated blades.

5) The kernel removing apparatus of claim 1, wherein the motor and the gearbox are affixed to a sidewall within the enclosed interior volume of the first housing.

6) A method of removing corn kernels from a cob of corn using a kernel removing apparatus, comprising:
providing a kernel removing apparatus comprising:
a first housing comprising:
a motor disposed within an enclosed interior volume of the first housing;
a gearbox, wherein the gearbox is operably connected to the motor;
a sleeve rotatably secured to the gearbox, wherein the sleeve is configured to receive a driveshaft;
a switch configured to actuate the motor;
a dial operably connected to the motor, wherein the dial is configured to adjust the revolutions per minute (RPM) of the driveshaft;
a second housing comprising:
a driveshaft;
a cutting assembly comprising a hollow tubular body having an open first end and a closed second end, wherein the first end comprises a circular blade and the second end is removably securable to the second end of the driveshaft; and
a conduit member having an input port and an output port;
actuating a motor of a kernel removing apparatus via a switch disposed on a first housing;
setting a dial of the kernel removing apparatus to a desired RPM for a driveshaft;
receiving a cob of corn within an input port of a conduit member;
cutting kernels from the cob of corn via a cutting assembly as the cob of corn is received through the input port towards the first housing;
discharging the kernels through the output port as the kernels are removed from the cob of corn;
depositing the corn kernels through an output port of the conduit member; and
receiving a core of the cob within a tubular body of the cutting assembly.
